(19) United States
(12) Patent Application Publication
(10) Pub. No.: US 2011/0267157 A1
(43) Pub. Date: Nov. 3, 2011

(54) Bistable relay

(76) Inventors: Simon Kalmbach, Altensteig (DE); Karl Steimle, Neubulach (DE); Gunter Kaiser, Jettingen (DE)

(21) Appl. No.: 13/093,178

(22) Filed: Apr. 25, 2011

(30) Foreign Application Priority Data
Apr. 29, 2010 (DE) 10 2010 018 738.0

(51) Int. Cl. H01H 51/22

(52) U.S. Cl. 335/78

(57) ABSTRACT

On a bistable relay, in particular for the high-current range, having a coil arrangement and a movable armature, which armature is attracted or repelled by the magnetic flux that can be generated in the coil arrangement and in the process opens or closes contacts, and in the relay, at least one retention element is provided, with which the armature is fixable in its position, an electric reservoir is provided, with the energy of which the armature is movable into an OFF position of the relay.

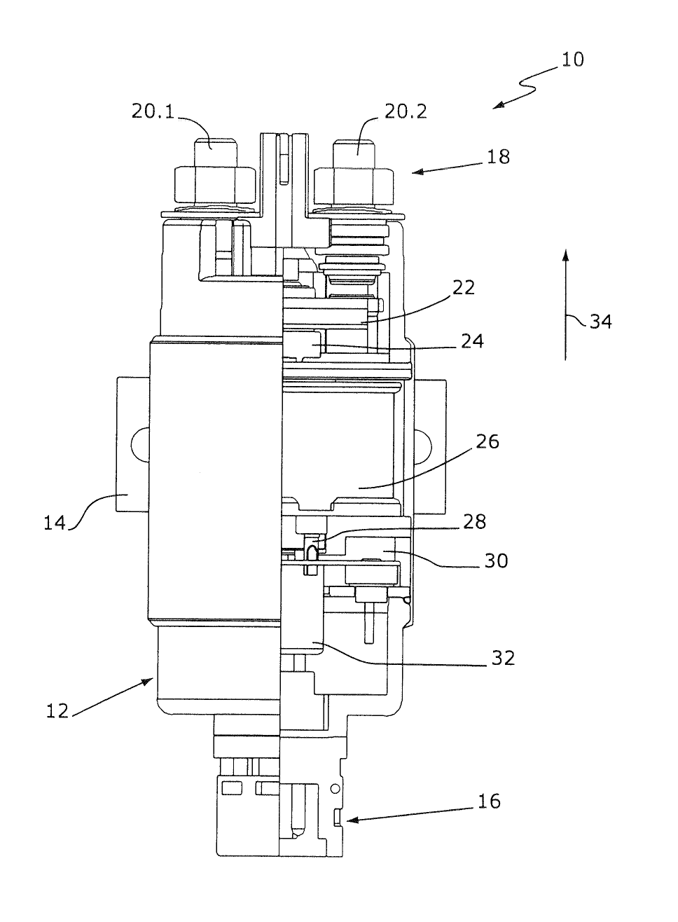

### CROSS-REFERENCE TO RELATED APPLICATION

The invention described and claimed hereinbelow is also described in German Patent Application DE 10 2010 018 738.0 filed on Apr. 29, 2010. This German Patent Application, whose subject matter is incorporated here by reference, provides the basis for a claim of priority of invention under 35 U.S.C. 119(a)-(d).

### BACKGROUND OF THE INVENTION

The invention relates to a bistable relay, in particular for the high-current range, having a coil arrangement and a movable armature, which armature is attracted or repelled by the magnetic flux that can be generated in the coil arrangement and in the process opens or closes contacts, and in the relay, at least one retention means is provided, with which the armature is fixable in its position.

One such relay has been disclosed by German Utility Model DE 297 24 595 U1. Bistable relays are used as switching elements in the most various areas of use in defense and air travel, in utility vehicles, vehicles that travel on rails, construction machines and floor conveyor machines. Until now, bistable relays had to be subjected externally, that is, at the customer, to a precisely defined coil signal for being switched on and off. Often, the result was field failures because of coils subjected to excess current. Moreover, until now bistable relays have still not had an automatic shutoff in the event of failure of the voltage supply.

DE 297 24 595 U1 discloses a bistable relay having at least one coil and a movable armature, in which even after the control current of the at least one coil is switched off, the armature can be kept in its position. For moving the armature into an OFF position of the relay, the known relay has to be subjected to a corresponding control current.

### SUMMARY OF THE INVENTION

By comparison, the object of the invention is to furnish a bistable relay whose armature can be moved into an OFF position of the relay without external control signals.

According to the invention, the object is attained by an electric reservoir, with the energy of which the armature can be moved into an OFF position of the relay. The trigger circuit can trigger the relay in such a way that upon application of a voltage to the relay, first the electric reservoir is charged, and then the relay is switched on. If the supply voltage fails, the electric reservoir can then take on the task of securely switching off the bistable relay. Thus by means of the electric reservoir, a relay with a safety shutoff can be achieved.

By means of the electric reservoir, the further advantage is obtained that the bistable relay can be triggered like a monostable relay, by way of only two terminals. One control signal suffices to move the armature into an ON position of the relay. For moving the armature into an OFF position, the relay no longer needs to be subjected to a control signal from outside. The electric reservoir furnishes the requisite current pulse for moving the armature for shutting off the relay.

The electric reservoir is preferably integrated with the relay. Because of the integration of the electric reservoir, a compact structure of the relay is possible. As a result, the relay can be used wherever a conventional monostable relay is to be replaced by a bistable relay without holding currents.

In a preferred feature of the invention, a capacitor can be provided as the electric reservoir. Capacitors can be charged and discharged quickly without having a memory effect.

The coil arrangement of the relay can have a single coil with two different windings for attracting and repelling the armature. In a preferred feature of the invention, the coil arrangement has one exciter coil and one ejector coil. The exciter coil and the ejector coil can be disposed one above the other or side by side in the same coil body.

Moreover, by means of the control unit, further safety functions, such as mispolarization protection, short-circuit protection, or a coil blowout, can be integrated with the relay. An undervoltage protector integrated with the control unit can moreover secure the relay against unintended operating states.

The control unit can preferably be embodied such that the relay of the invention can replace a conventional monostable relay, without having to change anything in the external triggering of the relay. Two or three terminals can be provided on the relay for controlling the relay. For controlling the relay, for instance either one common ground terminal or one common positive terminal as well as two further terminals for switching a relay on or off can be provided. In a further variant, two terminals can be provided for current supply and a third terminal with a virtually powerless control signal can be provided for switching the relay on and off.

The control unit can preferably be embodied on an essentially round circuit board on the housing of the coil arrangement. The coil contacts can moreover be extended through the circuit board. By the described arrangement of the circuit board, a compact structure of the relay is made possible, with at the same time simple supplying of power to all the relay elements that carry current.

In a further preferred feature of the invention, the individual elements of the relay can be dimensioned such that the relay is controllable by current pulses of a duration of less than 50 ms.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The sole FIGURE of the drawings is a view, partly in section, showing a bistable relay in according with the present invention.

### DESCRIPTION OF THE PREFERRED EMBODIMENTS

A bistable relay 10 of the invention has a housing 12 and a fastening arrangement 14. A DIN bayonet mount 16 is located on the housing 12 and by means of it the relay can be secured together with the fastening arrangement 14 in an application, such as a vehicle. The housing 12 is embodied as a metal housing, to shield the relay 10 against electrical and magnetic fields in the surroundings, for instance from motor.

A connection unit 18 is located in the upper part of the relay. The connection unit 18 has two main contact terminals 20.1 and 20.2. The two main contact terminals 20.1 and 20.2 can be connected electrically or disconnected, upon switching of the relay, by movement of a main contact bridge 22. The main contact bridge 22 is connected to an armature 24, which is moved when current is supplied to the coil arrangement 26. The coil arrangement has one exciter coil and one ejector coil. The coil arrangement 26 also has two permanent magnets (not shown), which once the coil current is switched off keep the armature 24 in the ON position or the OFF position. The coil arrangement 26 is electrically connected to a circuit board 30 by means of a coil bond 28. The circuit board 30 is in turn connected electrically to an energy reservoir 32. For controlling the relay 10, three control contacts (not shown) are provided in the connection unit 18.

If the relay 10 is triggered via the control contacts, then first the energy reservoir 32, which is embodied in the form of a capacitor, is charged. Next, the control signal on the circuit board 30 is modulated to a current surge with which the exciter coil is supplied. The armature 24 is moved upward in the direction of the arrow 34 as a result and connects the main contact terminals 20.1 and 20.2 by means of the main contact bridge 22. The armature 24 is kept in this position by a permanent magnet of the coil arrangement 26. Thus the relay 10 can be kept in the ON position virtually without power. For switching off the relay 10, the voltage is taken from the control contacts of the relay 10. This is recorded by the control unit 30. By means of the energy reservoir 32, the control unit 30 supplies current to the ejector coil of the coil arrangement 26; the armature is moved counter to the direction of the arrow 34 downward into the OFF position of the relay 10; and the main contact bridge 22 disconnects the main contact terminals 20.1 and 20.2 from one another. In the event of an unwanted drop in the voltage at the control contacts as well, the relay is thus switched off. Hence the relay 10 has an integrated safety shutoff.

The wiring of the control unit 30 can preferably be done in three ways. In a first variant, two control contacts are connected to a permanent voltage supply. In that case, the relay 10 can be switched on by a high level at a third control contact and switched off by a low level at the same control contact. In that case, virtually powerless switching is made possible by the control unit 30. In a second variant, a first control contact is connected to ground. Then, the relay 10 is switched on by application of a positive voltage to a second control contact and switched off again by a positive voltage at a third control contact. Finally, in a third variant, the relay 10 can be wired in such a way that a positive voltage is present at a first control contact, and the other two control contacts are subjected to a negative voltage for switching the relay on and off.

The wiring possibilities described above are to be considered merely as examples. The relay 10 of the invention can for instance also be controlled by only two control contacts, whose voltages are carried to the control unit 30.

The control unit 30 is embodied as short-circuit-proof and contains a protected coil triggering means, a mispolarization protector, and a coil blowout, so that erroneous or improper triggering is precluded. Moreover, the coil arrangement 26 is embodied so compactly that the, geometries and dimensions of the relay 10 of the invention are identical to conventional relays. The relay 10 of the invention can thus replace any corresponding conventional monostable or bistable relay. Compared to conventional relays, the electronic security of the relay 10 of the invention is markedly enhanced. By means of the integrated energy reservoir, a safety shutoff can be implemented.

It will be understood that each of the elements described above, or two or more together, may also find a useful application in other types of constructions differing from the types described above.

While the invention has been illustrated and described as embodied in a bistable relay, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A bistable relay, comprising a coil arrangement; a movable armature attracted or repelled by a magnetic flux generated in the coil arrangement and in a process opening or closing contacts; at least one retention means, with which the armature is fixable in its position; and an electric reservoir, with an energy of which the armature is movable into an OFF position of the relay.

2. The bistable relay as defined by claim 1, wherein the electric reservoir is integrated with the relay.

3. The bistable relay as defined by claim 1, further comprising a capacitor provided as the electric reservoir.

4. The bistable relay as defined by claim 1, wherein the coil arrangement has one exciter coil and one ejector coil.

5. The bistable relay as defined by claim 1, further comprising a control unit integrated with the relay and controlling a coil current.

6. The bistable relay as defined by claim 1, wherein two or three control contacts are provided for controlling the relay.

7. The bistable relay as defined by claim 5, wherein the control unit is embodied on a substantially round circuit board on a housing of the coil arrangement.

8. The bistable relay as defined by claim 7, further comprising a coil bond extended through the circuit board.

9. The bistable relay as defined by claim 1, wherein it is actuatable by current pulses of a duration of less than 50 ms.

10. The bistable relay as defined by claim 1, wherein the bistable relay is embodied as a relay for a high-current range.
